(19) United States
(12) Patent Application Publication
(10) Pub. No.: US 2023/0196251 A1
(43) Pub. Date: Jun. 22, 2023

(54) OUT OF STOCK REVENUE LOSS

(71) Applicant: Content Square SAS, Paris (FR)

(72) Inventors: Fatiha Achour, Paris (FR); Alfredo Castro, Paris (FR); Michael Colombier, Paris (FR); Filipe Posteral, Paris (FR); Krongkarn Jitsil, Paris (FR)

(21) Appl. No.: 17/716,948

(22) Filed: Apr. 8, 2022

Related U.S. Application Data
(60) Provisional application No. 63/292,731, filed on Dec. 22, 2021.

(51) Int. Cl. G06Q 10/06; G06Q 10/08

(52) U.S. Cl. CPC G06Q 10/06393; G06Q 10/087

(57) ABSTRACT

Systems and techniques may be used for providing a conversion loss insight. An example technique may include collecting pageviews for a plurality of users at a website, identifying an out of stock item that appeared in a subset of the pageviews during a time period, and retrieving a unit price of the out of stock item and a conversion rate corresponding to the out of stock item during the time period. The technique may include determining a loss indicator corresponding to lost revenue due to the out of stock item based on the subset of the pageviews, the unit price, and the conversion rate. The loss indicator may be output.

### CLAIM OF PRIORITY

This application claims the benefit of priority to U.S. Provisional Application No. 63/292,731 filed Dec. 22, 2021, titled “OUT OF STOCK REVENUE LOSS,” which is hereby incorporated herein by reference in its entirety.

### BACKGROUND

Web commerce has become a nearly universal way to sell products. Managing web commerce websites is often done by a team of people, who use web analytics to make design, structural, and interactive choices for the web commerce websites. Sales data from a website may be used to determine whether a product is successful. However, the sales data does not tell the entire story, nor does it provide sufficient data to make proactive decisions.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some nonlimiting examples are illustrated in the figures of the accompanying drawings in which:

FIG. 1 is a diagrammatic representation of a networked environment in which the present disclosure may be deployed, in accordance with some examples.

FIG. 2 is a diagrammatic representation of an experience analytics system, in accordance with some examples, that has both client-side and server-side functionality.

FIG. 3 is a diagrammatic representation of a data structure as maintained in a database, in accordance with some examples.

FIG. 4 is a flowchart for a process, in accordance with some examples.

FIG. 5 is a diagrammatic representation of a machine in the form of a computer system within which a set of instructions may be executed for causing the machine to perform any one or more of the methodologies discussed herein, in accordance with some examples.

FIG. 6 is a block diagram showing a software architecture within which examples may be implemented.

FIG. 7 is an example user interface showing out of stock revenue loss in accordance with some examples.

FIG. 8 illustrates example websites related to out of stock merchandise, in accordance with some examples.

### DETAILED DESCRIPTION

Systems and techniques described herein provide a conversion loss insight. When a user accesses a web page that includes an item for sale, the user may purchase the item. This may be referred to as a conversion. However, when the item is out of stock, the seller may not be able to convert the web page view to a sale. In cases where an item is out of stock (or listed as out of stock on the web page), the sale is lost. The loss of the sale may not be easily tracked, due to the lack of conversion. In some examples where multiple items are displayed on a web page, the loss may be even more difficult to track.

The system sand techniques described herein provide a way to track and identify the conversion loss based on page views, tracking of out of stock items, unit price of the out of stock items at time of pageview, and an average conversion (e.g., for a given web page, for a category of item, or for the item, such as based on historical data). In some examples, the item may be displayed with an out of stock icon to indicate that insights for the item are available for a web page owner or operator. The conversion loss may be displayed as a loss indicator, such as a number (e.g., a monetary value), which may be relative or absolute. The loss indicator may be qualitative, such as according to a color scheme, stars, etc.

In an example, the loss indicator may proportionally correspond to a number of page views while the item was out of stock. The loss indicator may be proportional to unit price at time of page view. The loss indicator may be proportional to an average conversion rate. For example, the number of page views may be multiplied by the unit price and multiplied by the average conversion rate to determine the loss indicator. The loss indicator may be displayed (e.g., on an owner or operator content page for reviewing web analytics).

### Networked Computing Environment

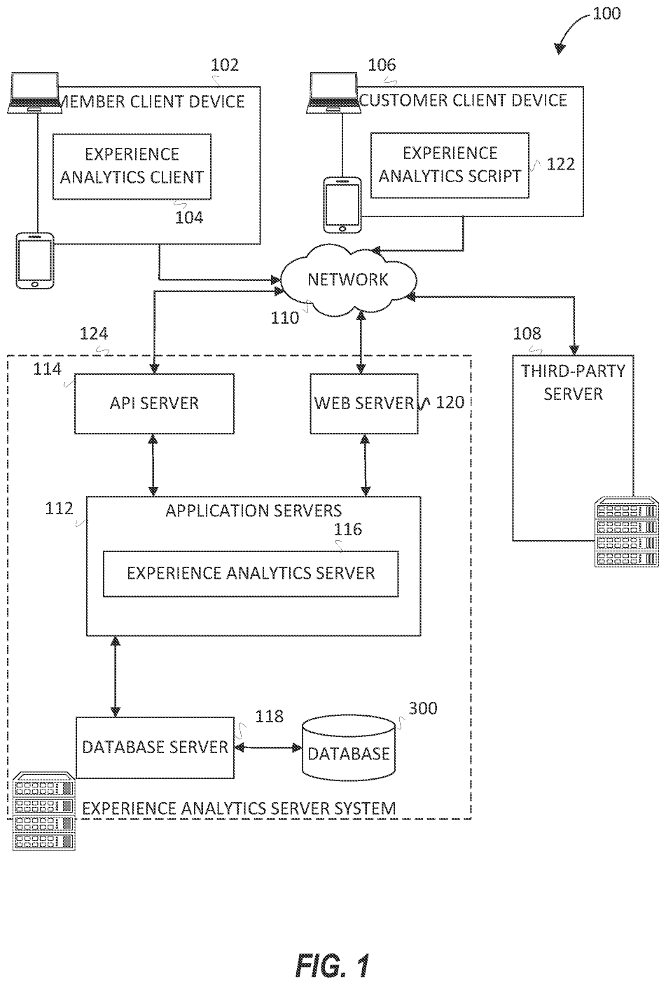

FIG. 1 is a block diagram showing an example experience analytics system 100 that analyzes and quantifies the user experience of users navigating a client's website, mobile websites, and applications. The experience analytics system 100 can include multiple instances of a member client device 102, multiple instances of a customer client device 106, and multiple instances of a third-party server 108.

The member client device 102 is associated with a client of the experience analytics system 100, where the client that has a website hosted on the client's third-party server 108. For example, the client can be a retail store that has an online retail website that is hosted on a third-party server 108. An agent of the client (e.g., a web administrator, an employee, etc.) can be the user of the member client device 102.

Each of the member client devices 102 hosts a number of applications, including an experience analytics client 104. Each experience analytics client 104 is communicatively coupled with an experience analytics server system 124 and third-party servers 108 via a network 110 (e.g., the Internet). An experience analytics client 104 can also communicate with locally-hosted applications using Applications Program Interfaces (APIs).

The member client devices 102 and the customer client devices 106 can also host a number of applications including Internet browsing applications (e.g., Chrome, Safari, etc.). The experience analytics client 104 can also be implemented as a platform that is accessed by the member client device 102 via an Internet browsing application or implemented as an extension on the Internet browsing application.

Users of the customer client device 106 can access client's websites that are hosted on the third-party servers 108 via the network 110 using the Internet browsing applications. For example, the users of the customer client device 106 can navigate to a client's online retail website to purchase goods or services from the website. While the user of the customer client device 106 is navigating the client's website on an Internet browsing application, the Internet browsing application on the customer client device 106 can also execute a client-side script (e.g., JavaScript (.*js)) such as an experience analytics script 122. In one example, the experience analytics script 122 is hosted on the third-party server 108 with the client's website and processed by the Internet browsing application on the customer client device 106. The experience analytics script 122 can incorporate a scripting language (e.g., a .*js file or a .json file).

In certain examples, a client's native application (e.g., ANDROID™ or IOS™ Application) is downloaded on the customer client device 106. In this example, the client's native application including the experience analytics script 122 is programmed in JavaScript leveraging a Software Development Kit (SDK) provided by the experience analytics server system 124. The SDK includes Application Programming Interfaces (APIs) with functions that can be called or invoked by the client's native application.

In one example, the experience analytics script 122 records data including the changes in the interface of the website being displayed on the customer client device 106, the elements on the website being displayed or visible on the interface of the customer client device 106, the text inputs by the user into the website, a movement of a mouse (or touchpad or touch screen) cursor and mouse (or touchpad or touch screen) clicks on the interface of the website, etc. The experience analytics script 122 transmits the data to experience analytics server system 124 via the network 110. In another example, the experience analytics script 122 transmits the data to the third-party server 108 and the data can be transmitted from the third-party server 108 to the experience analytics server system 124 via the network 110.

An experience analytics client 104 is able to communicate and exchange data with the experience analytics server system 124 via the network 110. The data exchanged between the experience analytics client 104 and the experience analytics server system 124, includes functions (e.g., commands to invoke functions) as well as payload data (e.g., website data, texts reporting errors, insights, merchandising information, adaptability information, images, graphs providing visualizations of experience analytics, session replay videos, zoning and overlays to be applied on the website, etc.).

The experience analytics server system 124 supports various services and operations that are provided to the experience analytics client 104. Such operations include transmitting data to and receiving data from the experience analytics client 104. Data exchanges to and from the experience analytics server system 124 are invoked and controlled through functions available via user interfaces (UIs) of the experience analytics client 104.

The experience analytics server system 124 provides server-side functionality via the network 110 to a particular experience analytics client 104. While certain functions of the experience analytics system 100 are described herein as being performed by either an experience analytics client 104 or by the experience analytics server system 124, the location of certain functionality either within the experience analytics client 104 or the experience analytics server system 124 may be a design choice. For example, it may be technically preferable to initially deploy certain technology and functionality within the experience analytics server system 124 but to later migrate this technology and functionality to the experience analytics client 104 where a member client device 102 has sufficient processing capacity.

Turning now specifically to the experience analytics server system 124, an Application Program Interface (API) server 114 is coupled to, and provides a programmatic interface to, application servers 112. The application servers 112 are communicatively coupled to a database server 118, which facilitates access to a database 300 that stores data associated with experience analytics processed by the application servers 112. Similarly, a web server 120 is coupled to the application servers 112, and provides web-based interfaces to the application servers 112. To this end, the web server 120 processes incoming network requests over the Hypertext Transfer Protocol (HTTP) and several other related protocols.

The Application Program Interface (API) server 114 receives and transmits message data (e.g., commands and message payloads) between the member client device 102 and the application servers 112. Specifically, the Application Program Interface (API) server 114 provides a set of interfaces (e.g., routines and protocols) that can be called or queried by the experience analytics client 104 or the experience analytics script 122 in order to invoke functionality of the application servers 112. The Application Program Interface (API) server 114 exposes to the experience analytics client 104 various functions supported by the application servers 112, including generating information on errors, insights, merchandising information, adaptability information, images, graphs providing visualizations of experience analytics, session replay videos, zoning and overlays to be applied on the website, etc.

The application servers 112 host a number of server applications and subsystems, including for example an experience analytics server 116. The experience analytics server 116 implements a number of data processing technologies and functions, particularly related to the aggregation and other processing of data including the changes in the interface of the website being displayed on the customer client device 106, the elements on the website being displayed or visible on the interface of the customer client device 106, the text inputs by the user into the website, a movement of a mouse (or touchpad) cursor and mouse (or touchpad) clicks on the interface of the website, etc. received from multiple instances of the experience analytics script 122 on customer client devices 106. The experience analytics server 116 implements processing technologies and functions, related to generating user interfaces including information on errors, insights, merchandising information, adaptability information, images, graphs providing visualizations of experience analytics, session replay videos, zoning and overlays to be applied on the website, etc. Other processor and memory intensive processing of data may also be performed server-side by the experience analytics server 116, in view of the hardware requirements for such processing.

### System Architecture

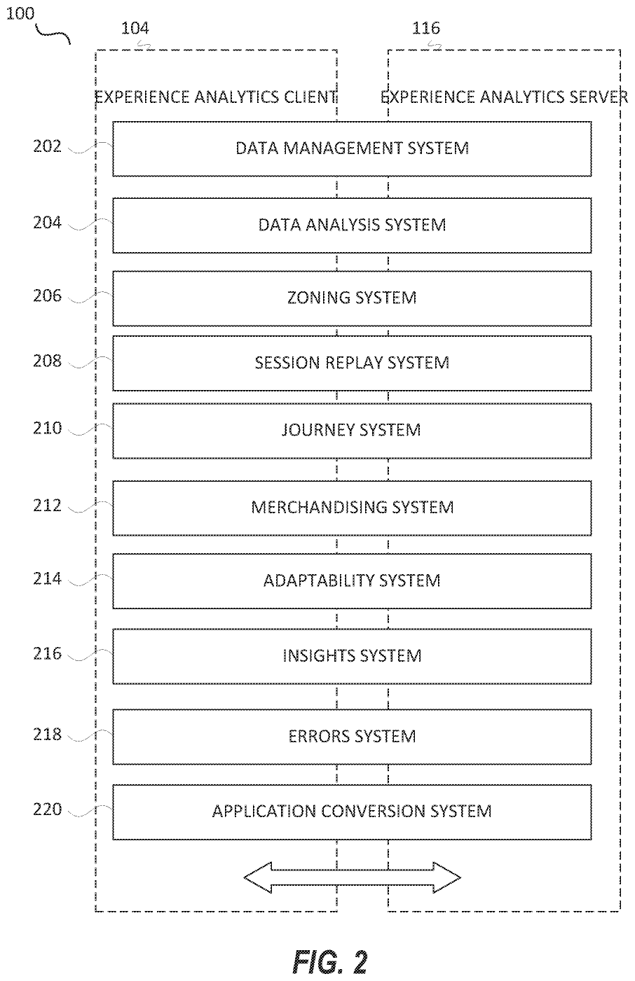

FIG. 2 is a block diagram illustrating further details regarding the experience analytics system 100 according to some examples. Specifically, the experience analytics system 100 is shown to comprise the experience analytics client 104 and the experience analytics server 116.

The experience analytics system 100 embodies a number of subsystems, which are supported on the client-side by the experience analytics client 104 and on the server-side by the experience analytics server 116. These subsystems include, for example, a data management system 202, a data analysis system 204, a zoning system 206, a session replay system 208, a journey system 210, a merchandising system 212, an adaptability system 214, an insights system 216, an errors system 218, and an application conversion system 220.

The data management system 202 is responsible for receiving functions or data from the member client devices 102, the experience analytics script 122 executed by each of the customer client devices 106, and the third-party servers 108. The data management system 202 is also responsible for exporting data to the member client devices 102 or the third-party servers 108 or between the systems in the experience analytics system 100. The data management system 202 is also configured to manage the third-party integration of the functionalities of experience analytics system 100.

The data analysis system 204 is responsible for analyzing the data received by the data management system 202, generating data tags, performing data science and data engineering processes on the data.

The zoning system 206 is responsible for generating a zoning interface to be displayed by the member client device 102 via the experience analytics client 104. The zoning interface provides a visualization of how the users via the customer client devices 106 interact with each element on the client's website. The zoning interface can also provide an aggregated view of in-page behaviors by the users via the customer client device 106 (e.g., clicks, scrolls, navigation). The zoning interface can also provide a side-by-side view of different versions of the client's website for the client's analysis. For example, the zoning system 206 can identify the zones in a client's website that are associated with a particular element in displayed on the website (e.g., an icon, a text link, etc.). Each zone can be a portion of the website being displayed. The zoning interface can include a view of the client's website. The zoning system 206 can generate an overlay including data pertaining to each of the zones to be overlaid on the view of the client's website. The data in the overlay can include, for example, the number of views or clicks associated with each zone of the client's website within a period of time, which can be established by the user of the member client device 102. In one example, the data can be generated using information from the data analysis system 204.

The session replay system 208 is responsible for generating the session replay interface to be displayed by the member client device 102 via the experience analytics client 104. The session replay interface includes a session replay that is a video reconstructing an individual user's session (e.g., visitor session) on the client's website. The user's session starts when the user arrives at the client's website and ends upon the user's exit from the client's website. A user's session when visiting the client's website on a customer client device 106 can be reconstructed from the data received from the user's experience analytics script 122 on customer client devices 106. The session replay interface can also include the session replays of a number of different visitor sessions to the client's website within a period of time (e.g., a week, a month, a quarter, etc.). The session replay interface allows the client via the member client device 102 to select and view each of the session replays. In one example, the session replay interface can also include an identification of events (e.g., failed conversions, angry customers, errors in the website, recommendations or insights) that are displayed and allow the user to navigate to the part in the session replay corresponding to the events such that the client can view and analyze the event.

The journey system 210 is responsible for generating the journey interface to be displayed by the member client device 102 via the experience analytics client 104. The journey interface includes a visualization of how the visitors progress through the client's website, page-by-page, from entry onto the website to the exit (e.g., in a session). The journey interface can include a visualization that provides a customer journey mapping (e.g., sunburst visualization). This visualization aggregates the data from all of the visitors (e.g., users on different customer client devices 106) to the website, and illustrates the visited pages and in order in which the pages were visited. The client viewing the journey interface on the member client device 102 can identify anomalies such as looping behaviors and unexpected drop-offs. The client viewing the journey interface can also assess the reverse journeys (e.g., pages visitors viewed before arriving at a particular page). The journey interface also allows the client to select a specific segment of the visitors to be displayed in the visualization of the customer journey.

The merchandising system 212 is responsible for generating the merchandising interface to be displayed by the member client device 102 via the experience analytics client 104. The merchandising interface includes merchandising analysis that provides the client with analytics on the merchandise to be promoted on the website, optimization of sales performance, the items in the client's product catalog on a granular level, competitor pricing, etc. The merchandising interface can, for example, comprise graphical data visualization pertaining to product opportunities, category, brand performance, etc. For instance, the merchandising interface can include the analytics on conversions (e.g., sales, revenue) associated with a placement or zone in the client website.

The adaptability system 214 is responsible for creating accessible digital experiences for the client's website to be displayed by the customer client devices 106 for users that would benefit from an accessibility-enhanced version of the client's website. For instance, the adaptability system 214 can improve the digital experience for users with disabilities, such as visual impairments, cognitive disorders, dyslexia, and age-related needs. The adaptability system 214 can, with proper user permissions, analyze the data from the experience analytics script 122 to determine whether an accessibility-enhanced version of the client's website is needed, and can generate the accessibility-enhanced version of the client's website to be displayed by the customer client device 106.

The insights system 216 is responsible for analyzing the data from the data management system 202 and the data analysis system 204 surface insights that include opportunities as well as issues that are related to the client's website. The insights can also include alerts that notify the client of deviations from a client's normal business metrics. The insights can be displayed by the member client devices 102 via the experience analytics client 104 on a dashboard of a user interface, as a pop-up element, as a separate panel, etc. In this example, the insights system 216 is responsible for generating an insights interface to be displayed by the member client device 102 via the experience analytics client 104. In another example, the insights can be incorporated in another interface such as the zoning interface, the session replay, the journey interface, or the merchandising interface to be displayed by the member client device 102.

The errors system 218 is responsible for analyzing the data from the data management system 202 and the data analysis system 204 to identify errors that are affecting the visitors to the client's website and the impact of the errors on the client's business (e.g., revenue loss). The errors can include the location within the user journey on the website and the page that adversely affects (e.g., causes frustration for) the users (e.g., users on customer client devices 106 visiting the client's website). The errors can also include causes of looping behaviors by the users, in-page issues such as unresponsive calls to action and slow loading pages, etc. The errors can be displayed by the member client devices 102 via the experience analytics client 104 on a dashboard of a user interface, as a pop-up element, as a separate panel, etc. In this example, the errors system 218 is responsible for generating an errors interface to be displayed by the member client device 102 via the experience analytics client 104. In another example, the insights can be incorporated in another interface such as the zoning interface, the session replay, the journey interface, or the merchandising interface to be displayed by the member client device 102.

The application conversion system 220 is responsible for the conversion of the functionalities of the experience analytics server 116 as provided to a client's website to a client's native mobile applications. For instance, the application conversion system 220 generates the mobile application version of the zoning interface, the session replay, the journey interface, the merchandising interface, the insights interface, and the errors interface to be displayed by the member client device 102 via the experience analytics client 104. The application conversion system 220 generates an accessibility-enhanced version of the client's mobile application to be displayed by the customer client devices 106.

The data management system 202 may store pageviews or unit prices corresponding to out of stock items. The data analysis system 204 may use the stored pageviews or unit prices, for example along with an average conversion rate, to determine a loss indicator for the out of stock item. The average conversion rate may be stored at the data management system 202. The loss indicator may be output from the experience analytics server 116, for example to a user device for display.

### Data Architecture

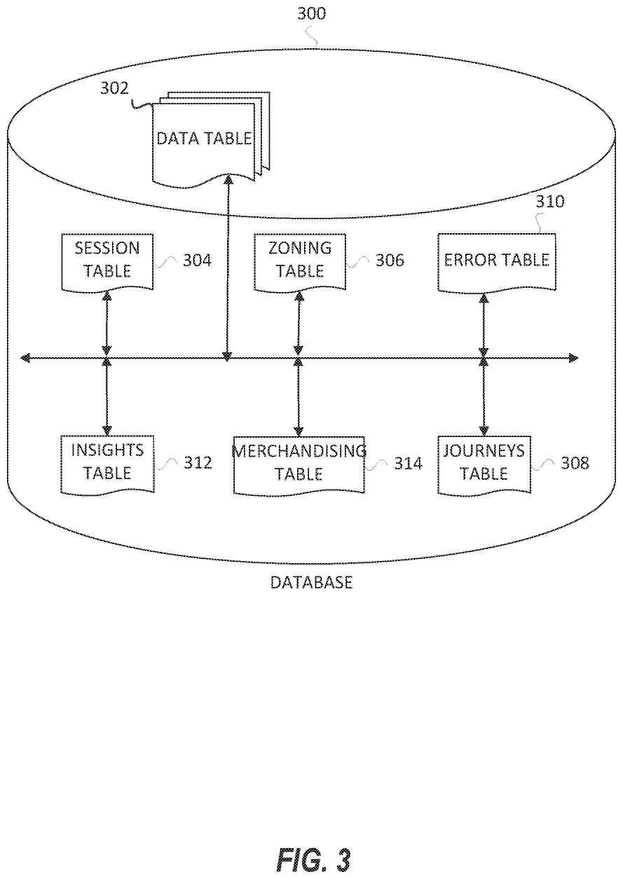

FIG. 3 is a schematic diagram illustrating database 300, which may be stored in the database 300 of the experience analytics server 116, according to certain examples. While the content of the database 300 is shown to comprise a number of tables, it will be appreciated that the data could be stored in other types of data structures (e.g., as an object-oriented database).

The database 300 includes a data table 302, a session table 304, a zoning table 306, an error table 310, an insights table 312, a merchandising table 314, and a journeys table 308.

The data table 302 stores data regarding the websites and native applications associated with the clients of the experience analytics system 100. The data table 302 can store information on the contents of the website or the native application, the changes in the interface of the website being displayed on the customer client device 106, the elements on the website being displayed or visible on the interface of the customer client device 106, the text inputs by the user into the website, a movement of a mouse (or touchpad or touch screen) cursor and mouse (or touchpad or touch screen) clicks on the interface of the website, etc. The data table 302 can also store data tags and results of data science and data engineering processes on the data. The data table 302 can also store information such as the font, the images, the videos, the native scripts in the website or applications, etc.

The session table 304 stores session replays for each of the client's websites and native applications.

The zoning table 306 stores data related to the zoning for each of the client's websites and native applications including the zones to be created and the zoning overlay associated with the websites and native applications.

The journeys table 308 stores data related to the journey of each visitor to the client's website or through the native application.

The error table 310 stores data related to the errors generated by the errors system 218 and the insights table 312 stores data related to the insights generated by the insights table 312.

The merchandising table 314 stores data associated with the merchandising system 212. For example, the data in the merchandising table 314 can include the product catalog for each of the clients, information on the competitors of each of the clients, the data associated with the products on the websites and applications, the analytics on the product opportunities and the performance of the products based on the zones in the website or application, etc.

### Process

Although the described flowcharts can show operations as a sequential process, many of the operations can be performed in parallel or concurrently. In addition, the order of the operations may be re-arranged. A process is terminated when its operations are completed. A process may correspond to a method, a procedure, an algorithm, etc. The operations of methods may be performed in whole or in part, may be performed in conjunction with some or all of the operations in other methods, and may be performed by any number of different systems, such as the systems described herein, or any portion thereof, such as a processor included in any of the systems.

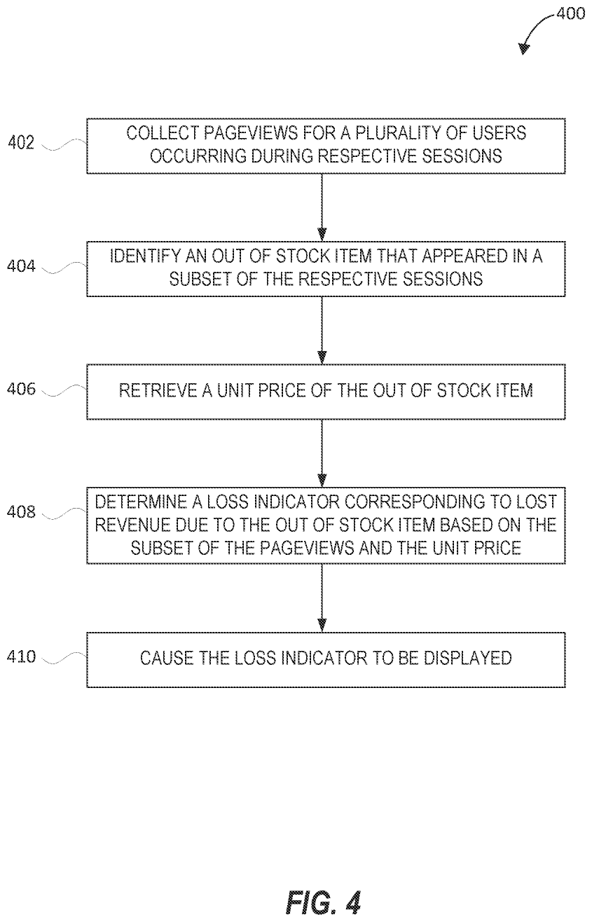

FIG. 4 is a schematic diagram illustrating a process 400, for providing information corresponding to revenue or conversion loss based on out of stock products.

The process 400 includes an operation 402 to collect pageviews for a plurality of users at a website, for example occurring during respective sessions. The process 400 includes an operation 404 to identify an out of stock item that appeared in a subset of the respective sessions. Operation 404 may include receiving a data push by an operator of the website.

The process 400 includes an operation 406 to retrieve a unit price of the out of stock item. Operation 406 may include determining the unit price for a particular time or for particular time frames, in some examples. Operation 406 may include retrieving a conversion rate corresponding to the out of stock item during the time period, for example a conversion rate of a category of product corresponding to the out of stock item. In some examples, the conversion rate may include multiple conversion rates corresponding to different time sub-periods during the time period. In some examples, retrieving the unit price includes querying saved data that was received from an operator of the website, the saved data including the unit price of the out of stock item. When the time period exceeds a threshold time period (e.g., a week), operation 406 may include retrieving a set of unit prices, each unit price of the set of unit prices corresponding to a respective sub-periods of time based on the threshold time period.

The process 400 includes an operation 408 to determine a loss indicator corresponding to lost revenue due to the out of stock item based on the subset of the respective sessions and the unit price. Operation 408 may include multiplying a count of the subset of respective sessions by the unit price by the conversion rate for the time period. The loss indicator may equal a number of the subset of respective sessions multiplied by the unit price at the respective times multiplied by an average conversion rate. In this example, the average conversion rate may correspond to a category of the out of stock item. In an example, operation 402 includes determining, for each hour within the time period, a stock status of the out of stock item. In this example, operation 408 may include calculating the lost revenue only for hours where the stock status indicated that the out of stock item was out of stock.

Operation 408 may include determining the loss indicator for a time period, such as a week, a month, etc. In this example, the average conversion rate may be taken on a periodic basis within the time period, such as a weekly basis. A conversion rate or unit price may vary in different time periods. For example, when an analysis context is ten days, a first conversion rate may be used for week one (e.g., seven days) and a second conversion rate may be used for week two (three days).

The process 400 includes an operation 410 to cause the loss indicator to be displayed. Operation 410 may include causing a plurality of loss indicators corresponding to a plurality of out of stock items to be displayed. The plurality of loss indicators may be displayed based on filtering out of stock items that do not fall within a particular filter. Filtering may include using a minimum number of pageviews of each of the corresponding out of stock items. In an example, filtering may include using an attribute of respective pageviews of the plurality of users for the corresponding out of stock items, for example where the attribute includes at least one of a loyalty program, a media campaign, a returning user status, or the like. In some examples, filtering may be based on a user specified tag (e.g., products may be pre-tagged, and the filtering may be based on these user-specific or brand-specific tags). Filtering may include using a category or a brand of the corresponding out of stock items. A category or brand may include multiple levels. For example, for an item that is a shoe, the category may have levels of “mens,” “shoe,” “sneaker,” etc. The results may be displayed for out of stock items that fit within that category only. A brand may include a company, a line, or a specific product brand.

The process 400 may include causing an out of stock visual indicator to be displayed on the out of stock item when displaying the loss indicator. In this example, the visual indicator may be displayed only when all variants of the out of stock item are out of stock. In some examples, the out of stock indicator may be displayed for particular variants. The process 400 may include causing a remaining item in stock visual indicator to be displayed on an in stock item when displaying the loss indicator. The remaining item in stock visual indicator may indicate remaining variants in stock for the in stock item.

### Machine Architecture

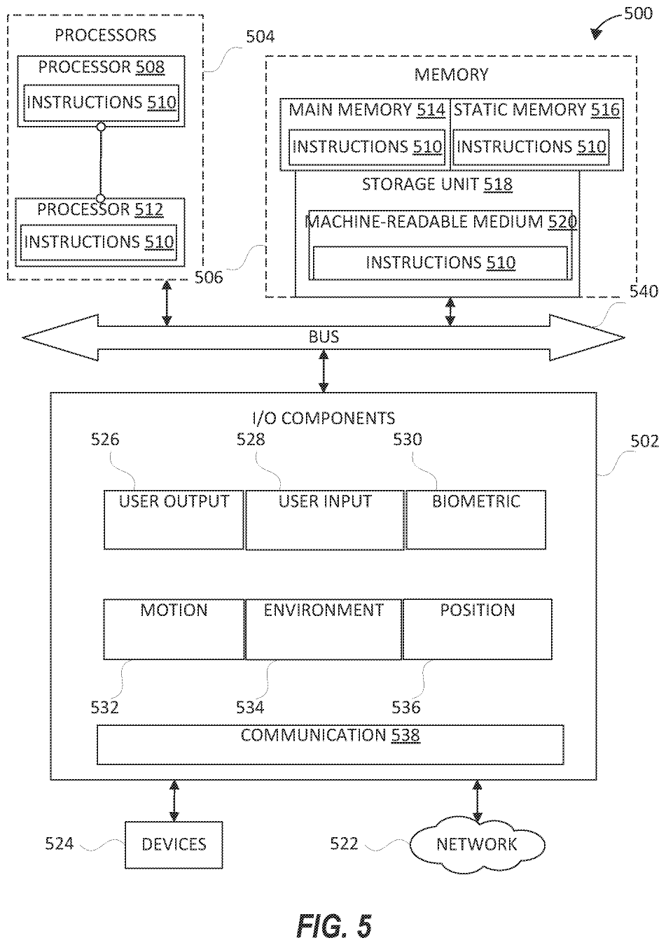

FIG. 5 is a diagrammatic representation of the machine 500 within which instructions 510 (e.g., software, a program, an application, an applet, an application, or other executable code) for causing the machine 500 to perform any one or more of the methodologies discussed herein may be executed. For example, the instructions 510 may cause the machine 500 to execute any one or more of the methods described herein. The instructions 510 transform the general, non-programmed machine 500 into a particular machine 500 programmed to carry out the described and illustrated functions in the manner described. The machine 500 may operate as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 510, sequentially or otherwise, that specify actions to be taken by the machine 500. Further, while only a single machine 500 is illustrated, the term “machine” shall also be taken to include a collection of machines that individually or jointly execute the instructions 510 to perform any one or more of the methodologies discussed herein. The machine 500, for example, may comprise the member client device 102 or any one of a number of server devices forming part of the experience analytics server 116. In some examples, the machine 500 may also comprise both client and server systems, with certain operations of a particular method or algorithm being performed on the server-side and with certain operations of the particular method or algorithm being performed on the client-side.

The machine 500 may include processors 504, memory 506, and input/output I/O components 502, which may be configured to communicate with each other via a bus 540. In an example, the processors 504 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 508 and a processor 512 that execute the instructions 510. The term “processor” is intended to include multi-core processors that may comprise two or more independent processors (sometimes referred to as “cores”) that may execute instructions contemporaneously. Although FIG. 5 shows multiple processors 504, the machine 500 may include a single processor with a single-core, a single processor with multiple cores (e.g., a multi-core processor), multiple processors with a single core, multiple processors with multiples cores, or any combination thereof.

The memory 506 includes a main memory 514, a static memory 516, and a storage unit 518, both accessible to the processors 504 via the bus 540. The main memory 506, the static memory 516, and storage unit 518 store the instructions 510 embodying any one or more of the methodologies or functions described herein. The instructions 510 may also reside, completely or partially, within the main memory 514, within the static memory 516, within machine-readable medium 520 within the storage unit 518, within at least one of the processors 504 (e.g., within the processor's cache memory), or any suitable combination thereof, during execution thereof by the machine 500.

The I/O components 502 may include a wide variety of components to receive input, provide output, produce output, transmit information, exchange information, capture measurements, and so on. The specific I/O components 502 that are included in a particular machine will depend on the type of machine. For example, portable machines such as mobile phones may include a touch input device or other such input mechanisms, while a headless server machine will likely not include such a touch input device. It will be appreciated that the I/O components 502 may include many other components that are not shown in FIG. 5. In various examples, the I/O components 502 may include user output components 526 and user input components 528. The user output components 526 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 528 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 502 may include biometric components 530, motion components 532, environmental components 534, or position components 536, among a wide array of other components. For example, the biometric components 530 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 532 include acceleration sensor components (e.g., accelerometer), gravitation sensor components, rotation sensor components (e.g., gyroscope).

The environmental components 534 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the member client device 102 may have a camera system comprising, for example, front cameras on a front surface of the member client device 102 and rear cameras on a rear surface of the member client device 102. The front cameras may, for example, be used to capture still images and video of a user of the member client device 102 (e.g., “selfies”). The rear cameras may, for example, be used to capture still images and videos in a more traditional camera mode. In addition to front and rear cameras, the member client device 102 may also include a 360° camera for capturing 360° photographs and videos.

Further, the camera system of a member client device 102 may include dual rear cameras (e.g., a primary camera as well as a depth-sensing camera), or even triple, quad or penta rear camera configurations on the front and rear sides of the member client device 102. These multiple cameras systems may include a wide camera, an ultra-wide camera, a telephoto camera, a macro camera and a depth sensor, for example.

The position components 536 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 502 further include communication components 538 operable to couple the machine 500 to a network 522 or devices 524 via respective coupling or connections. For example, the communication components 538 may include a network interface component or another suitable device to interface with the network 522. In further examples, the communication components 538 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 524 may be another machine or any of a wide variety of peripheral devices (e.g., a peripheral device coupled via a USB).

Moreover, the communication components 538 may detect identifiers or include components operable to detect identifiers. For example, the communication components 538 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 538, such as location via Internet Protocol (IP) geolocation, location via Wi-Fi® signal triangulation, location via detecting an NFC beacon signal that may indicate a particular location, and so forth.

The various memories (e.g., main memory 514, static memory 516, and memory of the processors 504) and storage unit 518 may store one or more sets of instructions and data structures (e.g., software) embodying or used by any one or more of the methodologies or functions described herein. These instructions (e.g., the instructions 510), when executed by processors 504, cause various operations to implement the disclosed examples.

The instructions 510 may be transmitted or received over the network 522, using a transmission medium, via a network interface device (e.g., a network interface component included in the communication components 538) and using any one of several well-known transfer protocols (e.g., hypertext transfer protocol (HTTP)). Similarly, the instructions 510 may be transmitted or received using a transmission medium via a coupling (e.g., a peer-to-peer coupling) to the devices 524.

### Software Architecture

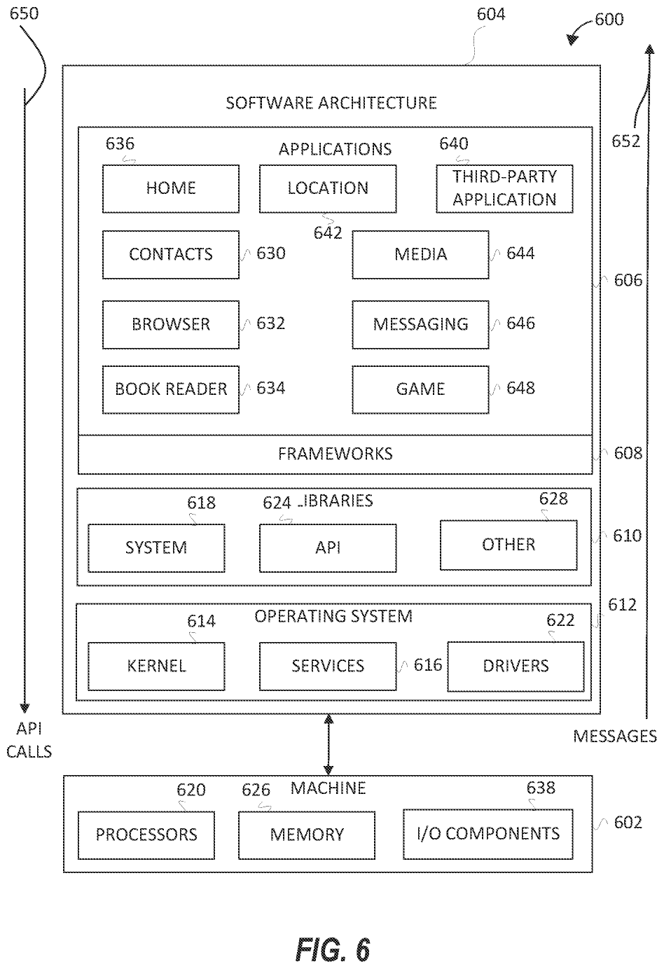

FIG. 6 is a block diagram 600 illustrating a software architecture 604, which can be installed on any one or more of the devices described herein. The software architecture 604 is supported by hardware such as a machine 602 that includes processors 620, memory 626, and I/O components 638. In this example, the software architecture 604 can be conceptualized as a stack of layers, where each layer provides a particular functionality. The software architecture 604 includes layers such as an operating system 612, libraries 610, frameworks 608, and applications 606. Operationally, the applications 606 invoke API calls 650 through the software stack and receive messages 652 in response to the API calls 650.

The operating system 612 manages hardware resources and provides common services. The operating system 612 includes, for example, a kernel 614, services 616, and drivers 622. The kernel 614 acts as an abstraction layer between the hardware and the other software layers. For example, the kernel 614 provides memory management, processor management (e.g., scheduling), component management, networking, and security settings, among other functionalities. The services 616 can provide other common services for the other software layers. The drivers 622 are responsible for controlling or interfacing with the underlying hardware. For instance, the drivers 622 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 610 provide a common low-level infrastructure used by the applications 606. The libraries 610 can include system libraries 618 (e.g., C standard library) that provide functions such as memory allocation functions, string manipulation functions, mathematic functions, and the like. In addition, the libraries 610 can include API libraries 624 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 610 can also include a wide variety of other libraries 628 to provide many other APIs to the applications 606.

The frameworks 608 provide a common high-level infrastructure that is used by the applications 606. For example, the frameworks 608 provide various graphical user interface (GUI) functions, high-level resource management, and high-level location services. The frameworks 608 can provide a broad spectrum of other APIs that can be used by the applications 606, some of which may be specific to a particular operating system or platform.

In an example, the applications 606 may include a home application 636, a contacts application 630, a browser application 632, a book reader application 634, a location application 642, a media application 644, a messaging application 646, a game application 648, and a broad assortment of other applications such as a third-party application 640. The applications 606 are programs that execute functions defined in the programs. Various programming languages can be employed to create one or more of the applications 606, structured in a variety of manners, such as object-oriented programming languages (e.g., Objective-C, Java, or C++) or procedural programming languages (e.g., C or assembly language). In a specific example, the third-party application 640 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 640 can invoke the API calls 650 provided by the operating system 612 to facilitate functionality described herein.

### User Interfaces

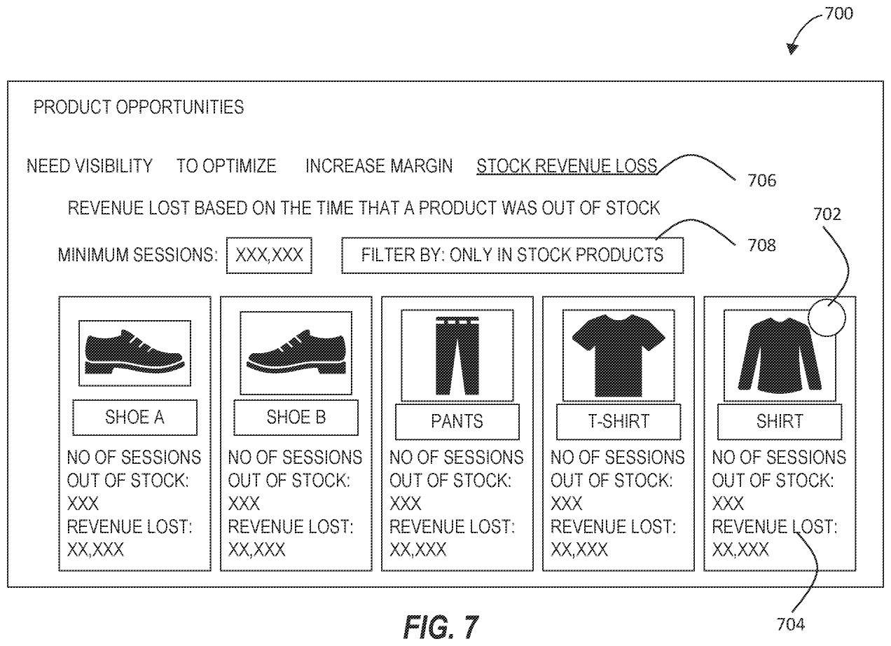

FIG. 7 illustrates an example user interface 700. The user interface 700 illustrates various products (e.g., Shoe A, T-shirt, etc.). One item in the user interface 700 is currently listed as out of stock, the “Shirt.” To signify this status, the user interface 700 includes an indication 702, which may be differentiated in some examples with a color (e.g., red) to draw visual attention to the indication 702. The indication 702 may be sized in some examples, such as to show how long the item has been out of stock or how large a revenue loss occurred or is occurring due to the item being out of stock. The indication 702 may be selectable, such as to view further detail or breakdown information related to the revenue loss.

In an example, the user interface 700 may correspond to a merchandising analytics web page, app page, or other user interface. The user interface 700 indicates when a product is out of stock and identifies an amount of revenue lost because of the out of stock situation. Products out of stock may be identified or displayed based on impact of the out of stock products by category or brands. In some examples, products or categories of products may be ranked by revenue loss or opportunity (e.g., restocking may provide a particular benefit, such as based on restocking anticipation). When information regarding stock availability is provided by a web page owner or operator, the availability of the product may be displayed (e.g., amount of stock available or available/not available). In an example, some values of stock may include: “in stock”, “yes”, “y”, “true”, “1”, “out of stock”, “no”, “n”, “false”, “0,” or values indicating number of items in stock. When a number in stock is shown, products may be filtered with a quantity range.

The user interface 700 includes estimated revenue lost indicators for each of the items that were out of stock, for example indicator 704, which shows a revenue lost based on a number of sessions out of stock for the item. The sessions may correspond to a user interaction with a website with one or more pageviews during a time period (e.g., from when a website is initially visited until the website (or a related website) is closed or reloaded, or when a timeout occurs). The sessions displayed may indicate a number of sessions with at least one pageview of a product page when the product was out of stock. The revenue lost may correspond to the sessions, a unit price during each of the sessions (which may be the same in some examples), and an average conversion rate. The average conversion rate may correspond to the item (e.g., based on historical conversion rates for the item or a current conversion rate), to a category of the item (e.g., shoes, shirts, books, etc., which may be further divided into categories such as athletic shoes or dress shoes, science fiction books or romance books, or the like), to a particular web store or page, or the like.

The revenue lost shown in the example indicator 704 may be equal to a number of visits when the item was out of stock multiplied by a unit price at the time of the visits multiplied by an average conversion rate of the category during a time period (e.g., a week). The average conversion rate may be taken on a daily, weekly, monthly, or other time period basis. In an example, a conversion rate may be generated on a daily, weekly, monthly, or other time period basis. For example, for an eight day period, the conversion rate may include eight separate conversion rates (e.g., one per day), two conversion rates (e.g., one for a first week and one for a second week), one conversion rate (e.g., monthly), or an average conversion rate (e.g., based on eight daily, two weekly, or based on some other time period), or the like.

When an analysis context timeframe differs from the average conversion rate time period (e.g., ten days), the conversion rate (CR) may be an average of the CR of a first week (e.g., seven days) and of the CR of a second week (e.g., three days). In some examples, the average may be a weighted average (e.g., weighted seven to three in favor of the first week over the second week).

The user interface 700 may be displayed in response to a user selection of a “stock revenue loss” indicator 706. Results may be displayed in the user interface 700, the results based on a determination of at least one product that represented lost revenue due to being out of stock. A user may filter or search for results, for example based on time period (e.g., over calendar dates), or time a product was out of stock (e.g., all products out of stock for at least a week), based on product status (e.g., products now in stock), based on sales data (e.g., products with sales since being out of stock or sales before being out of stock, such as a minimum number or amount of sales), type of product, etc. A filter component 708 may be used to filter or search by product type, for example. Other filter or search options may include using a threshold (e.g., minimum, maximum, range, etc.) number of sessions (e.g., pageviews of an out of stock item), threshold revenue loss, threshold conversion rate, or the like. In an example, the filter may include options to show only active products, only in stock products, or only out of stock products.

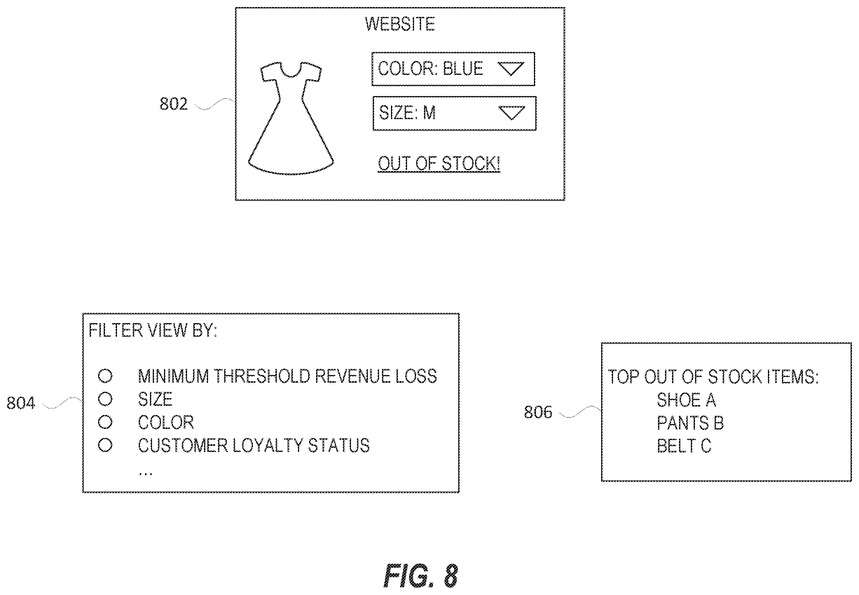

FIG. 8 illustrates example website related to out of stock merchandise, in accordance with some examples. A first example website 802 displays a user facing website including a product, with optional variants (e.g., size, color, etc.), and an indication that the current product or current selection (e.g., variant) is out of stock. The out of stock item on the first example website 802 may be displayed in a manner that differs from the how the item is displayed when in stock (e.g., faded, greyed out, dotted, partially transparent, etc.). A selectable purchase indication may be removed or un-selectable on the first example website 802 when the item is out of stock. When a user visits the first example website 802, a pageview may be counted. Pageviews for the out of stock item may be aggregated for users who view the out of stock item on the first example website 802 (or elsewhere), to obtain a total pageview count of views of the out of stock item over a time period (e.g., while the item is out of stock, over a day, a week, a month, etc.).

In some examples, an item may be in stock and out of stock over a time period. For example, the item may be out of stock on a first day, in stock days two to four, and out of stock again on day five. Over this five day time period, the item is out of stock two days and in stock three days. An out of stock revenue loss may be calculated for the item based on the two out of stock days for the time period. A daily, weekly, hourly, etc. average revenue loss may be displayed in some examples (e.g., instead of or in addition to a total revenue loss over a time period). An item may be checked for whether it is out of stock against a stored product catalogue feed, which may be updated on a periodic basis, for example, every hour, every day, or the like.

After pageviews are aggregated, lost revenue may be calculated for a product. The lost revenue may be determined on a rolling or periodic basis, or may be determined on demand (e.g., when a user requests lost revenue information). The on demand determination may include using filtered data, such as according to a user specification. A second example website 804 may be used to filter results of out of stock revenue loss products. Filtering (or searching) may be done based on a variety of features of products, revenue loss, or the like. For example, a user may filter results of out of stock revenue loss products based on thresholds (e.g., minimum, maximum, a range, etc.) for revenue loss, conversion rate, pageviews, or the like. A user may filter based on product attributes, such as size, color, etc. In some examples, a user may filter based on an attribute of a user corresponding to a pageview. In these examples, the filtering may be done based on customer loyalty status (e.g., show only users who have a loyalty status), login status (e.g., show only users who were logged into the site when accessing an out of stock product), previous purchasers (e.g., users who have previously purchased something from the website, or who have purchased the out of stock product), source of pageview (e.g., via a media campaign, such as an email link, an ad on a search engine, a direct link, a selection of a link from a landing page or home page, etc.), or the like.

The second example website 804 may be used to filter results that were already calculated in an example. In another example, the second example website 804 may be used to pre-filter and generate new results based on the pre-filtering. Other types of filtering or searching may use the second example website 804 to generate or display results. For example, a user may select a custom time period (e.g., last X number of hours, days, weeks, etc.) for one or more products. Relevant results for out of stock revenue lost corresponding to products in that custom time period may be displayed (and optionally further filtered or pre-filtered). The lost revenue may correspond to times when the product was out of stock during the custom time period, although the product may also have been in stock during certain portions of the custom time period.

A third example website 806 may be used to display information corresponding to out of stock revenue loss items. For example, items may be ranked and displayed according to the ranking. The ranking may include highest revenue loss over a time period, highest conversion rate corresponding to an out of stock item during a time period, most pageviews of an out of stock item during a time period, etc. The ranking may be customized by a user, such as including only filtered results (e.g., as described above with respect to the second example website 804), using a custom time frame, items with a lost revenue, conversion rate, or pageview count traversing a particular threshold (e.g., a minimum, a maximum, or a range), or the like.

### Glossary

“Carrier signal” refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

“Client device” refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors 1004 or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Ephemeral message” refers to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices: magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers to a tangible medium that is capable of storing, encoding, or carrying the instructions for execution by a machine.

“Signal medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

Example 1 is a method of providing a conversion loss insight, the method comprising: collecting pageviews for a plurality of users; identifying an out of stock item that appeared in a subset of the pageviews; retrieving a unit price of the out of stock item at respective times of the subset of pageviews; determining a loss indicator corresponding to lost revenue due to the out of stock item based on the subset of the pageviews and the unit price; and causing the loss indicator to be displayed.

In Example 2, the subject matter of Example 1 includes, wherein the loss indicator equals a number of the subset of pageviews multiplied by the unit price at the respective times multiplied by an average conversion rate.

In Example 3, the subject matter of Example 2 includes, wherein the average conversion rate corresponds to a category of the out of stock item.

In Example 4, the subject matter of Examples 1-3 includes, wherein determining the loss indicator includes determining the loss indicator for a time period of a week.

In Example 5, the subject matter of Examples 1-4 includes, causing an out of stock visual indicator to be displayed on the out of stock item when displaying the loss indicator.

In Example 6, the subject matter of Example 5 includes, wherein causing the visual indicator to be displayed includes causing the visual indicator to be displayed only when all variants of the out of stock item are out of stock.

In Example 7, the subject matter of Examples 1-6 includes, causing a remaining item in stock visual indicator to be displayed on an in stock item when displaying the loss indicator.

In Example 8, the subject matter of Example 7 includes, wherein the remaining item in stock visual indicator indicates remaining variants in stock for the in stock item.

Example 9 is a computing apparatus, the computing apparatus comprising: a processor; and a memory storing instructions that, when executed by the processor, configure the apparatus to: collect pageviews for a plurality of users; identify an out of stock item that appeared in a subset of the pageviews; retrieve a unit price of the out of stock item at respective times of the subset of pageviews; determine a loss indicator corresponding to lost revenue due to the out of stock item based on the subset of the pageviews and the unit price; and cause the loss indicator to be displayed.

In Example 10, the subject matter of Example 9 includes, wherein the loss indicator equals a number of the subset of pageviews multiplied by the unit price at the respective times multiplied by an average conversion rate.

In Example 11, the subject matter of Example 10 includes, wherein the average conversion rate corresponds to a category of the out of stock item.

In Example 12, the subject matter of Examples 9-11 includes, wherein to determine the loss indicator includes to determine the loss indicator for a time period of a week.

In Example 13, the subject matter of Examples 9-12 includes, wherein the apparatus is further configured to cause an out of stock visual indicator to be displayed on the out of stock item when displaying the loss indicator.

In Example 14, the subject matter of Example 13 includes, wherein to cause the visual indicator to be displayed includes to cause the visual indicator to be displayed only when all variants of the out of stock item are out of stock.

In Example 15, the subject matter of Examples 9-14 includes, wherein the apparatus is further configured to cause a remaining item in stock visual indicator to be displayed on an in stock item when displaying the loss indicator.

In Example 16, the subject matter of Example 15 includes, wherein the remaining item in stock visual indicator indicates remaining variants in stock for the in stock item.

Example 17 is a method of providing a conversion loss insight, the method comprising: collecting, at a server, pageviews for a plurality of users at a website occurring during respective sessions; identifying an out of stock item that appeared in a subset of the respective sessions during a time period; retrieving a unit price of the out of stock item and a conversion rate corresponding to the out of stock item during the time period; determining, using a processor, a loss indicator corresponding to lost revenue due to the out of stock item based on the subset of the respective sessions, the unit price, and the conversion rate; and causing the loss indicator to be displayed.

In Example 18, the subject matter of Example 17 includes, wherein identifying the out of stock item includes receiving a data push by an operator of the website.

In Example 19, the subject matter of Examples 17-18 includes, wherein retrieving the unit price includes querying saved data that was received from an operator of the website, the saved data including the unit price of the out of stock item.

In Example 20, the subject matter of Examples 17-19 includes, wherein identifying the out of stock item includes determining, for each hour within the time period, a stock status of the out of stock item, and wherein determining the loss indicator includes calculating the lost revenue only for hours where the stock status indicated that the out of stock item was out of stock.

In Example 21, the subject matter of Examples 17-20 includes, wherein, when the time period exceeds a week, retrieving the conversion rate includes retrieving a set of unit prices, each unit price of the set of unit prices corresponding to a respective week.

In Example 22, the subject matter of Examples 17-21 includes, wherein causing the loss indicator to be displayed includes causing a plurality of loss indicators corresponding to a plurality of out of stock items to be displayed.

In Example 23, the subject matter of Example 22 includes, wherein causing the plurality of loss indicators to be displayed includes filtering corresponding out of stock items of the plurality of out of stock items according to a minimum number of pageviews of each of the corresponding out of stock items.

In Example 24, the subject matter of Examples 22-23 includes, wherein causing the plurality of loss indicators to be displayed includes filtering corresponding out of stock items of the plurality of out of stock items according to an attribute of respective pageviews of the plurality of users for the corresponding out of stock items, the attribute including at least one of a loyalty program, a media campaign, or a returning user status.

In Example 25, the subject matter of Examples 22-24 includes, wherein causing the plurality of loss indicators to be displayed includes filtering corresponding out of stock items of the plurality of out of stock items according to a category or a brand of the corresponding out of stock items.

In Example 26, the subject matter of Examples 17-25 includes, wherein the conversion rate corresponds to a category of the out of stock item.

In Example 27, the subject matter of Examples 17-26 includes, causing an out of stock visual indicator to be displayed on the out of stock item when causing the loss indicator to be displayed.

Example 28 is a computing apparatus, the computing apparatus comprising: a processor; and a memory storing instructions that, when executed by the processor, configure the apparatus to: collect pageviews for a plurality of users at a website occurring during respective sessions; identify an out of stock item that appeared in a subset of the respective sessions during a time period; retrieve a unit price of the out of stock item and a conversion rate corresponding to the out of stock item during the time period, determine a loss indicator corresponding to lost revenue due to the out of stock item based on the subset of the respective sessions, the unit price, and the conversion rate; and cause the loss indicator to be displayed.

In Example 29, the subject matter of Example 28 includes, wherein to cause the loss indicator to be displayed includes causing a plurality of loss indicators corresponding to a plurality of out of stock items to be displayed.

In Example 30, the subject matter of Example 29 includes, wherein to cause the plurality of loss indicators to be displayed includes filtering corresponding out of stock items of the plurality of out of stock items according to a minimum number of pageviews of each of the corresponding out of stock items.

In Example 31, the subject matter of Examples 29-30 includes, wherein to cause the plurality of loss indicators to be displayed includes filtering corresponding out of stock items of the plurality of out of stock items according to an attribute of respective pageviews of the plurality of users for the corresponding out of stock items, the attribute including at least one of a loyalty program, a media campaign, or a returning user status.

In Example 32, the subject matter of Examples 29-31 includes, wherein to cause the plurality of loss indicators to be displayed includes filtering corresponding out of stock items of the plurality of out of stock items according to a category or a brand of the corresponding out of stock items.

Example 33 is at least one non-transitory machine-readable medium including instructions, which when executed by processing circuitry, causes the processing circuitry to perform operations to: collect pageviews for a plurality of users at a website occurring during respective sessions; identify an out of stock item that appeared in a subset of the respective sessions during a time period; retrieve a unit price of the out of stock item and a conversion rate corresponding to the out of stock item during the time period; determine a loss indicator corresponding to lost revenue due to the out of stock item based on the subset of the respective sessions, the unit price, and the conversion rate; and cause the loss indicator to be displayed.

In Example 34, the subject matter of Example 33 includes, wherein to retrieve the unit price includes querying saved data that was received from an operator of the website, the saved data including the unit price of the out of stock item.

In Example 35, the subject matter of Examples 33-34 includes, wherein to identify the out of stock item includes determining, for each hour within the time period, a stock status of the out of stock item, and wherein to determine the loss indicator includes calculating the lost revenue only for hours where the stock status indicated that the out of stock item was out of stock.

In Example 36, the subject matter of Examples 33-35 includes, wherein, when the time period exceeds a week, to retrieve the conversion rate includes retrieving a set of unit prices, each unit price of the set of unit prices corresponding to a respective week.

Example 37 is at least one machine-readable medium including instructions that, when executed by processing circuitry, cause the processing circuitry to perform operations to implement of any of Examples 1-36.

Example 38 is an apparatus comprising means to implement of any of Examples 1-36.

Example 39 is a system to implement of any of Examples 1-36.

Example 40 is a method to implement of any of Examples 1-36.

1. A method of providing a conversion loss insight, the method comprising:
collecting, at a server, pageviews for a plurality of users at a website occurring during respective sessions;
identifying an out of stock item that appeared in a subset of the respective sessions during a time period;
retrieving a unit price of the out of stock item and a conversion rate corresponding to the out of stock item during the time period, the conversion rate including an average number of conversions of the out of stock item during an in stock time period for the out of stock item;
determining, using a processor, a loss indicator corresponding to lost revenue due to the out of stock item based on the subset of the respective sessions, the unit price, and the conversion rate, the loss indicator being equal to a number of the subset of respective sessions multiplied by the unit price multiplied by the conversion rate;
ranking the out of stock item based on the loss indicator among a set of out of stock items with corresponding loss indicators; and
causing the loss indicator to be displayed according to the ranking in a user interface.

2. The method of claim 1, wherein identifying the out of stock item includes receiving a data push by an operator of the website.

3. The method of claim 1, wherein retrieving the unit price includes querying saved data that was received from an operator of the website, the saved data including the unit price of the out of stock item.

4. The method of claim 1, wherein identifying the out of stock item includes determining, for each hour within the time period, a stock status of the out of stock item, and wherein determining the loss indicator includes calculating the lost revenue only for hours where the stock status indicated that the out of stock item was out of stock.

5. The method of claim 1, wherein, when the time period exceeds a week, retrieving the conversion rate includes retrieving a set of unit prices, each unit price of the set of unit prices corresponding to a respective week.

6. The method of claim 1, wherein causing the loss indicator to be displayed includes causing a plurality of loss indicators corresponding to a plurality of out of stock items to be displayed.

7. The method of claim 6, wherein causing the plurality of loss indicators to be displayed includes filtering corresponding out of stock items of the plurality of out of stock items according to a minimum number of pageviews of each of the corresponding out of stock items.

8. The method of claim 6, wherein causing the plurality of loss indicators to be displayed includes filtering corresponding out of stock items of the plurality of out of stock items according to an attribute of respective pageviews of the plurality of users for the corresponding out of stock items, the attribute including at least one of a loyalty program, a media campaign, or a returning user status.

9. The method of claim 6, wherein causing the plurality of loss indicators to be displayed includes filtering corresponding out of stock items of the plurality of out of stock items according to a category or a brand of the corresponding out of stock items.

10. The method of claim 1, wherein the conversion rate corresponds to a category of the out of stock item.

11. The method of claim 1, further comprising causing an out of stock visual indicator to be displayed on the out of stock item when causing the loss indicator to be displayed.

12. A computing apparatus, the computing apparatus comprising:
a processor; and
a memory storing instructions that, when executed by the processor, configure the apparatus to:
collect pageviews for a plurality of users at a website occurring during respective sessions;
identify an out of stock item that appeared in a subset of the respective sessions during a time period, the conversion rate including an average number of conversions of the out of stock item during an in stock time period for the out of stock item;
retrieve a unit price of the out of stock item and a conversion rate corresponding to the out of stock item during the time period;
determine a loss indicator corresponding to lost revenue due to the out of stock item based on the subset of the respective sessions, the unit price, and the conversion rate, the loss indicator being equal to a number of the subset of respective sessions multiplied by the unit price multiplied by the conversion rate;
ranking the out of stock item based on the loss indicator among a set of out of stock items with corresponding loss indicators; and
cause the loss indicator to be displayed according to the ranking in a user interface.

13. The computing apparatus of claim 12, wherein to cause the loss indicator to be displayed includes causing a plurality of loss indicators corresponding to a plurality of out of stock items to be displayed.

14. The computing apparatus of claim 13, wherein to cause the plurality of loss indicators to be displayed includes filtering corresponding out of stock items of the plurality of out of stock items according to a minimum number of pageviews of each of the corresponding out of stock items.

15. The computing apparatus of claim 13, wherein to cause the plurality of loss indicators to be displayed includes filtering corresponding out of stock items of the plurality of out of stock items according to an attribute of respective pageviews of the plurality of users for the corresponding out of stock items, the attribute including at least one of a loyalty program, a media campaign, or a returning user status.

16. The computing apparatus of claim 13, wherein to cause the plurality of loss indicators to be displayed includes filtering corresponding out of stock items of the plurality of out of stock items according to a category or a brand of the corresponding out of stock items.

17. At least one non-transitory machine-readable medium including instructions, which when executed by processing circuitry, causes the processing circuitry to perform operations to:
collect pageviews for a plurality of users at a website occurring during respective sessions;
identify an out of stock item that appeared in a subset of the respective sessions during a time period;
retrieve a unit price of the out of stock item and a conversion rate corresponding to the out of stock item during the time period, the conversion rate including an average number of conversions of the out of stock item during an in stock time period for the out of stock item;
determine a loss indicator corresponding to lost revenue due to the out of stock item based on the subset of the respective sessions, the unit price, and the conversion rate, the loss indicator being equal to a number of the subset of respective sessions multiplied by the unit price multiplied by the conversion rate;
ranking the out of stock item based on the loss indicator among a set of out of stock items with corresponding loss indicators; and
cause the loss indicator to be displayed according to the ranking in a user interface.

18. The at least one non-transitory machine-readable medium of claim 17, wherein to retrieve the unit price includes querying saved data that was received from an operator of the website, the saved data including the unit price of the out of stock item.

19. The at least one non-transitory machine-readable medium of claim 17, wherein to identify the out of stock item includes determining, for each hour within the time period, a stock status of the out of stock item, and wherein to determine the loss indicator includes calculating the lost revenue only for hours where the stock status indicated that the out of stock item was out of stock.

20. The at least one non-transitory machine-readable medium of claim 17, wherein, when the time period exceeds a week, to retrieve the conversion rate includes retrieving a set of unit prices, each unit price of the set of unit prices corresponding to a respective week.
